(19) United States
(12) Patent Application Publication
(10) Pub. No.: US 2024/0062516 A1
(43) Pub. Date: Feb. 22, 2024

(54) ERGONOMIC CLASSIFICATIONS

(71) Applicant: Hewlett-Packard Development Company, L.P., Spring, TX (US)

(72) Inventors: Abhishek Ghosh, Spring, TX (US); Sandip Brahmachary, Pune (IN); Manohar Lal Kalwani, Pune (IN)

(73) Assignee: Hewlett-Packard Development Company, L.P., Spring, TX (US)

(21) Appl. No.: 18/261,058

(22) PCT Filed: May 25, 2021
(86) PCT No.: PCT/US2021/033979

§ 371 Date: Jul. 11, 2023

(30) Foreign Application Priority Data
Jan. 27, 2021 (IN) 202141003599

(51) Int. Cl. G06V 10/764; G06V 10/766; G06V 10/94; G09G 5/10; G06F 3/16

(52) U.S. Cl. CPC G06V 10/764; G06V 10/766; G06V 10/945; G09G 5/10; G06F 3/165; G09G 2320/068; G09G 2340/04; G09G 2354/00; G09G 2360/145; G06F 3/012

(57) ABSTRACT

An example electronic device includes a display device, and a sensor to detect position data of a user of the electronic device. The position data indicates a position and orientation of the user relative to the display device. In addition, the electronic device includes a controller coupled to the sensor and the display device. The controller is to: receive the position data from the sensor; use a machine learning model and the position data to classify an interaction of the user with the electronic device in a first ergonomic category or a second ergonomic category; and adjust an angular position of a display device or an output from the display device responsive to a classification of the interaction in the first ergonomic category.

### BACKGROUND

Prolonged interaction with electronic devices can lead to a number of physical injuries and conditions (collectively referred to herein as “injuries”). In some cases, medical treatment, including surgery, may be administered to address such injuries. Proper body positioning, as well as proper electronic device settings may be used to prevent such injuries from occurring or to lessen their severity.

### BRIEF DESCRIPTION OF THE DRAWINGS

Various examples are described below referring to the following figures:

FIG. 1 is a schematic view of a user interacting with an electronic device according to some examples;

FIG. 2 is a schematic view of an electronic device according to some examples;

FIG. 3 is a chart of benchmark data that may be collected and used according to some examples; and

FIGS. 4-6 are schematic diagrams of machine-readable instructions for changing an ergonomic classification of a user's interaction with an electronic device according to some examples.

### DETAILED DESCRIPTION

To prevent injury, a user of an electronic device may employ proper body positioning (e.g., posture) and electronic device settings (e.g., display settings, sound settings). However, it can be difficult for a user to assess their current positioning and/or settings. Moreover, what may be considered proper body posturing and electronic device settings may change depending on the user's environment and other transient factors.

Accordingly, examples disclosed herein include electronic devices that may receive data from a sensor (or a plurality of sensors), and based on the received data, may classify a user's interaction with the electronic device as either ergonomic or unergonomic. In some examples, the electronic devices may use machine learning models to classify the user's interaction with the electronic device as unergonomic, and responsive to the classification, determine (and potentially automatically implement) corrections to various parameters, positions, settings, etc. of the electronic device to change the classification to ergonomic. Thus, through use of the examples disclosed herein, a user may more consistently achieve and maintain ergonomic interaction with the electronic device so as to avoid injury.

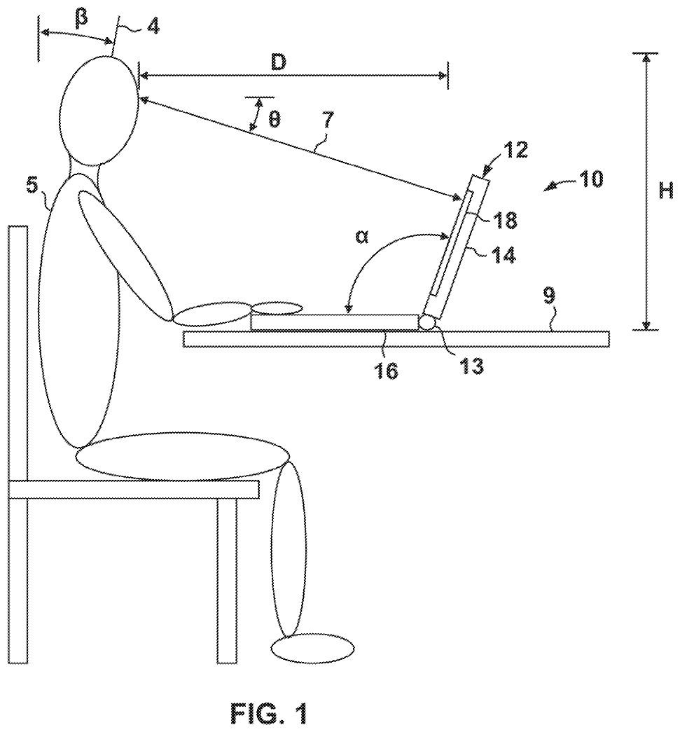

Reference is now made to FIG. 1, which shows a user 5 interacting with an electronic device 10. The term “electronic device” may comprise any device that may execute machine-readable instructions. For instance, an electronic device may comprise a computer (e.g., a desktop computer, laptop computer, tablet computer, all-in-one computer), a server, or a smartphone. The electronic device 10 of FIG. 1 is a laptop computer that includes a housing 12 including a first housing member 14 pivotably coupled to a second housing member 16 with a hinge 13.

The first housing member 14 may support a display device 18 for presenting images (e.g., text, graphics, pictures, videos, symbols) to user 5. User 5 may change the rotative position of the first housing member 14, relative to the second housing member 16 about the hinge 13, to adjust an angle α between the first housing member 14 and second housing member 16 about the axis of rotation of hinge 13 during operations.

Several angles, measurements, positions, and settings may contribute to an overall classification of the interaction of the user 5 with the electronic device 10 as ergonomic or unergonomic. For example, the position and orientation of the user 5 relative to electronic device 10 (and particularly to display device 18) may result in posture that may lead to injuries to the back, neck, and/or shoulders of the user 5.

In some examples, the position and orientation of the user 5 relative to the electronic device 10 may be characterized by various parameters including a viewing distance D, a head tilt angle β, a viewing angle θ, a head height H, etc.

The viewing distance D may be measured from the face of the user 5 (or a particular facial feature, such as the eyes) to the display device 18 (to an edge of the display device 18, the center of the display device 18, etc.). The head tilt angle β may comprise an angle formed between a centerline 4 extending from the head of the user 5 relative to vertical (or to another reference line that may be considered neutral for the head and neck of the user 5). The head tilt angle β may be characteristic of the bending angle of the neck of the user 5, with a tilt angle R of 0° corresponding to a neutral or straight neck. The viewing angle θ may comprise the angle formed between the line of sight 7 extending from the eyes of the user 5 to the display device 18 and to the horizontal direction. The head height H may comprise the vertical height of the head of the user 5 (or some other body part, such as the shoulders or eyes) from the support surface of the electronic device 10 such as the table-top 9 shown in FIG. 1. In some examples, the head height H may be measured from some other reference point or component on the electronic device 10 (e.g., a point, surface, or component on the first or second housing members 14, 16, the hinge 13, a sensor, etc.).

In addition, settings of the electronic device 10 may also be relevant to classifying the interaction of the user 5 with the electronic device 10 as ergonomic or unergonomic. For instance, improper output parameters of the display device 18, such as font size, brightness, etc. may contribute to eye strain or other vision related injuries for user 5. In some instances, the appropriateness of the output parameters of the display device 18 may be influenced by the position and orientation of the user (e.g., via the parameters D, H, α, θ, β), and/or by other factors (e.g., such as whether the user's iris contracted, the ambient light, relative humidity of the surrounding environment, whether the user 5 is wearing corrective lenses and whether those lenses are convex or concave).

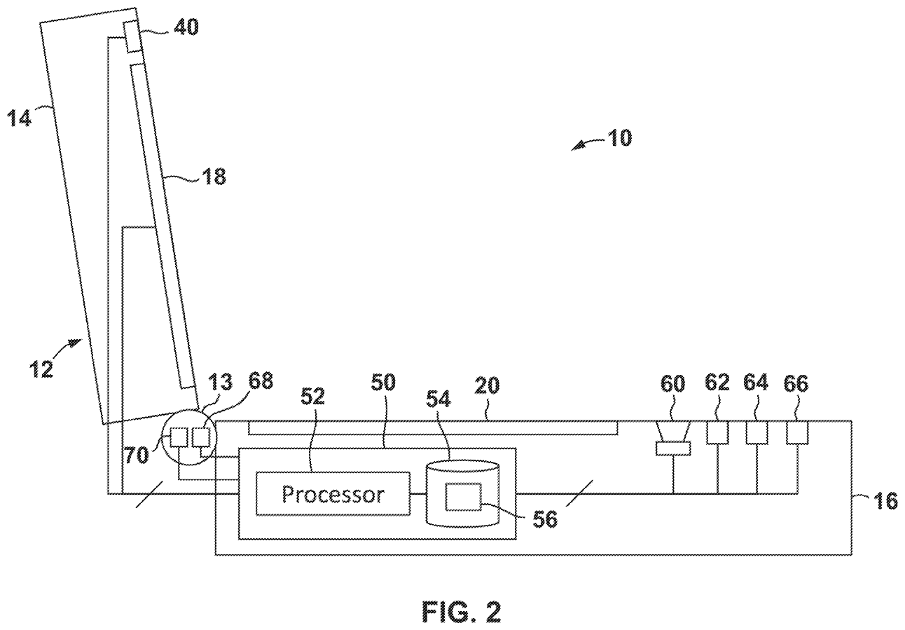

Further, improper volume settings for speakers of the electronic device 10 (e.g., speaker 60 in FIG. 2) may contribute to hearing loss or other hearing related injuries for user 5. As with the output parameters of the display device 18, the appropriateness of the volume output by the speaker(s) of the electronic device 10 may be influenced by the position and orientation of the user (e.g., via the parameters D, H, α, θ, β), and/or by other factors (e.g., ambient noise levels, speaker type).

As described in more detail below, electronic device 10 may receive data relating to the position and orientation of the user 5 relative to the electronic device 10 (or the display device 18), the output from the display device 18, and/or the speaker output to determine whether the interaction of the user 5 with the electronic device 10 is ergonomic or unergonomic. Further details of the structure and components of electronic device 10 are now described below to explain the functionality of electronic device 10 during operations.

Referring now to FIGS. 1 and 2, in addition to display device 18, electronic device 10 may comprise a user input assembly 20 in the second housing member 16. The user input assembly 20 may comprise a device (or a collection of devices) for receiving user inputs during operations. For instance, in some examples, user input assembly 20 may comprise a keyboard, trackpad, etc. Also, the electronic device 10 may include a speaker 60. Speaker 60 comprises a device (or an array of devices) that may output audible sound. Speaker 60 may be actuated to output sound from electronic device 10 during operations. For instance, speaker 60 may output sound effects, music and/or other audio feeds, etc. from electronic device 10.

In addition, electronic device 10 may include a controller 50 which further comprises a processor 52 and a memory 54. The processor 52 may comprise any suitable processing device, such as a microcontroller, central processing unit (CPU), graphics processing unit (GPU), timing controller (TCON), a scaler unit. The processor 52 executes machine-readable instructions (e.g. machine-readable instructions 56) stored on memory 54, thereby causing the processor 52 (and, more generally, electronic device 10) to perform some or all of the actions attributed herein to the processor 52 (and, more generally, to electronic device 10). More specifically, processor 52 fetches, decodes, and executes instructions (e.g., machine-readable instructions 56). In addition, processor 52 may also perform other actions, such as, making determinations, detecting conditions or values, etc., and communicating signals. If processor 52 assists another component in performing a function, then processor 52 may be said to cause the component to perform the function.

The memory 54 may comprise volatile storage (e.g., random access memory (RAM)), non-volatile storage (e.g., flash storage, etc.), or combinations of both volatile and non-volatile storage. Data read or written by the processor 52 when executing machine-readable instructions can also be stored on memory 54. Memory 54 may comprise “non-transitory machine readable medium.”

The processor 52 may comprise one processing device or a plurality of processing devices that are distributed within electronic device 10. Likewise, the memory 54 may comprise one memory device or a plurality of memory devices that are distributed within the electronic device 10. For instance, in some examples, controller 50 (or a component thereof) may be distributed within the first housing member 14 and the second housing member 16. In addition, in some examples, controller 50 (or a component thereof) may be positioned within another electronic device (not shown) that is communicatively coupled to electronic device 10 via a network or other suitable connection.

Further, electronic device 10 may include a plurality of sensors communicatively coupled to controller 50 that are to measure, detect, infer, etc. the various parameters discussed above for determining whether a user (e.g., user 5) is interacting with the electronic device 10 in an ergonomic or unergonomic manner. For instance, in some examples, the electronic device 10 includes an image sensor 40, a light sensor 62, a microphone 64, a humidity sensor 66, angle detecting sensor 68, etc.

Image sensor 40 may comprise any suitable sensor or sensor array that is to detect images in or outside the visible light spectrum (e.g., infrared, ultraviolet). In some examples, image sensor 40 comprises a camera (e.g., a video camera). During operations, image sensor 40 is to capture images of a user (e.g., user 5 in FIG. 1) of electronic device 10. In some examples, the image sensor 40 is positioned along a topmost side of the display device 18. However, the precise location of image sensor 40 may be varied in different examples, including various locations in either the first housing member 14 or the second housing member 16.

Controller 50 may receive images captured by the image sensor 40 (or data that is representative of the captured images). In addition, controller 50 may analyze images captured by the image sensor 40 to determine a position of a user's 5 face (or particular features thereof, such as the eyes) relative to the display device 18 and/or other components of electronic device 10. Any suitable analysis techniques may be used by controller 50 to determine a position of the user's 5 face. For instance, in some examples, the controller 50 may analyze the relative location of various facial features (e.g., eyes, nose, mouth) to determine an orientation of the user's 5 face relative to the display device 18. In addition, the controller 50 may analyze images captured by the image sensor 40 to determine a distance between the display device 18 and the user's 5 face, such as by analyzing the relative sizing and spacing of the user's 5 face (or facial features thereof) and objects in the images that are positioned at known distances from the display device 18 (e.g., components of electronic device 10). In some examples, the controller 50 may interrogate a time-of-flight or other suitable proximity sensor (not shown) either alone or in combination with the image(s) captured by the image sensor 40 to determine the distance between the display device 18 and the user of the electronic device 10. Based on the analysis, the controller 50 may determine the various parameters described above for characterizing the position and orientation of the user 5 relative to the electronic device 10 (or more particularly display device 18) (e.g., D, H, β, θ).

In addition to the position and orientation of the user 5 (FIG. 1), controller 50 may also analyze the images captured by image sensor 40 for other information. For instance, in some examples, controller 50 may determine (using the image sensor 40) whether the user 5 is wearing corrective lenses, and whether the lenses are concave or convex. Also, in some examples, controller 50 may determine (using the image sensor 40) whether and to what extend to the user's 5 irises are contracted or expanded. As described in more detail below, these additional parameters may also be used when classifying the interaction of the user 5 and electronic device 10 as ergonomic or unergonomic.

Light sensor 62 may comprise a device (or an array of devices) that may measure or detect the amount of light within an environment. In general, the light sensor 62 may detect ambient light levels within the environment surrounding electronic device 10, and communicate the detected light to the controller 50. The controller 50 may then analyze the output signals from light sensor 62 to make determinations, such as, the ambient light levels of the environment surrounding electronic device 10.

Microphone 64 comprises a device (or an array of devices) that may receive or collect sound waves traveling within the environment surrounding electronic device 10. The collected sound waves may be communicated to controller 50, which may then analyze the collected sound waves to determine a number of parameters, such as, the ambient noise levels, pitch and/or frequency of a person's voice, etc.

Humidity sensor 66 may measure or detect the relative humidity within the environment surrounding electronic device 10. The humidity sensor 66 may measure or detect both water vapor and the temperature within the environment surrounding the electronic device 10 to allow a determination of the relative humidity within the environment surrounding electronic device 10 (e.g., via controller 50) during operations. Without being limited to this or any other theory, the relative humidity of the environment surrounding the electronic device 10 may affect a user's ability to clearly see the images emitted from display device 18. Accordingly, as the relative humidity increases, other parameters of the display device 18 may also be adjusted (e.g., font size, brightness) to avoid unergonomic conditions.

In addition, electronic device 10 may also include an angle detecting sensor 68 that may detect or measure the rotative position of first housing member 14 about hinge 13. In some examples, the angle detecting sensor 68 may measure or detect the angle α between the first housing member 14 and second housing member 16 shown in FIG. 1. Angle detecting sensor 68 may comprise any suitable device (or devices) for detecting the rotative of position of the first housing member 14 relative to the second housing member 16 about hinge 13 (e.g., gyroscopes, magnetic sensor such as a hall effect sensor). During operations, output signals from angle detecting sensor 68 may be used by controller 50 to determine the angle α shown in FIG. 1.

Referring still to FIGS. 1 and 2, during operations, controller 50 may receive data from the image sensor 40, light sensor 62, microphone 64, humidity sensor 66, angle detecting sensor 68, and potentially other sources. Using the received data, controller 50 may classify the interaction of the user 5 with the electronic device 10 as ergonomic or unergonomic.

For instance, based on the received data, controller 50 may determine the position and orientation of the user 5 relative to a display device 18. As previously described, the position and orientation of user 5 may be characterized by various measurements, angles, and other parameters (e.g., D, H, a, 6, P). The data received and used by controller 50 to determine these various position-characterizing parameters may be referred to herein as “position data.” The position data may be received by controller 50 from one or a plurality of sources (e.g., image sensor 40, angle detecting sensor 68).

In addition, based on the received data, controller 50 may determine various output parameters of the display device 18. For instance, the output parameters of the display device 18 may comprise, display brightness, display contrast, font size, etc. The data received and used by controller 50 to determine the output parameters of the display device 18 may be referred to has “image output data.” The image output data may be received by controller 50 from one or a plurality of sources (e.g., display device 18, a GPU of electronic device 10, CPU of electronic device 10).

Further, based on the received data, the controller 50 may determine an environmental condition of the environment surrounding the electronic device 10. The environmental condition may comprise the ambient noise levels, volume output by the speaker 60, ambient light brightness or intensity, and/or relative humidity of the environment surrounding electronic device 10. The data received and used by the controller 50 to determine the environmental condition may be referred to herein as “environmental data,” The environmental data may be received by controller 50 from one or a plurality of sources (e.g., microphone 64, light sensor 62, humidity sensor 66, speaker 60).

The controller 50 may use a first machine learning model to classify the interaction of the user 5 and the electronic device 10 as unergonomic or ergonomic. In particular, the controller 50 may provide the position data, the image output data, and/or the environmental data (and/or the parameters determined by the controller 50 using the position data, image output data, and/or environmental data as described above) to the first machine learning model, and in turn, the first machine learning model may provide an output indicative of the classification of the interaction of the user 5 and electronic device 10. The first machine learning model may classify the interaction of the user 5 and electronic device 10 into one of two categories: a first ergonomic category to indicate the interaction is unergonomic; and a second ergonomic category to indicate that the interaction is ergonomic.

In some examples, the first machine learning model may comprise a logistic regression model, a random forest model, an extreme gradient boosting model, etc. In some examples, the first machine learning model may classify the current interaction of the user 5 with the electronic device 10 as either ergonomic or un-ergonomic based on relationships between the position data, the environmental data, and/or the image output data (or parameters determined by the controller 50 using the position data, image output data, and/or the environmental data).

In some examples, the data provided to the first machine learning model may first be processed by the controller 50. For instance, in some examples, the data provided to the first machine learning model (e.g., the position data, image output data, environmental data, and/or other parameters determined therewith), may be subjected to filtering, normalization, transformation, conversion, and/or other processing techniques.

In some examples, the first machine learning model may be trained and selected using labeled data. The labeled data may comprise position data, environmental data, and/or image output data (and/or parameters that may be determined using the position data, environmental data, and/or image output data as described above) that are known to correspond with an ergonomic or unergonomic interaction between a user and an electronic device. The labeled data may be derived from experimentation in a controlled environment (e.g., laboratory, factory, research facility, office), and may provide data and parameters to represent a wide variety of situations and scenarios (e.g., such as users having different builds, sizes, genders, ages as well as different environmental conditions).

To select and train the first machine learning model, the labeled data may be provided to a plurality of classification models (which may comprise logistic regression models, random forest models, extreme gradient boosting models, and/or other types of machine learning models) to derive and validate the coefficients for the plurality of classification models to properly classify interactions represented by the labeled data as ergonomic or unergonomic. More specifically, in some examples the plurality of classification models may be provided with a first portion of the labeled data to derive the coefficients for the models, and a second portion (different from the first portion) of the labeled data to validate the derived coefficients. In some examples, a third portion (different from the first and second portions) of the labeled data may be used to test the plurality of classification models following derivation and validation of the coefficients to determine which of the models provides the most accurate prediction of ergonomic or unergonomic interaction between a user and the electronic device 10. In some examples, the first portion of the labeled data may comprise approximately 60% of the labeled data, and the second and third portions of the labeled data may each comprise approximately 20% of the labeled data.

In some examples, the training and selection of the first machine learning model may be performed at a controlled environment (e.g., laboratory, factory, research facility, office), so that when a user interacts with the electronic device 10 (e.g., following purchase or assignment of the electronic device 10), the controller 50 may receive the position data, the environmental data, and/or the image output data and use the received data (and/or parameters determined using the received data) with the first machine learning model (which was previously trained and selected with labeled data as described above) to classify the interaction of the user and the electronic device 10 as ergonomic or unergonomic. In some examples, the controller 50 may refine the coefficients of the first machine learning model using collected data of the user 5.

In some examples, if the interaction of the user 5 and the electronic device 10 is classified as unergonomic via the the first machine learning model, the position data, image output data, the environmental data, and/or other parameters determined therewith may be used with a second machine learning model to determine corrections to a parameter or parameters of the electronic device 10 to change the classification of the interaction from unergonomic to ergonomic. For instance, in some examples, the second machine learning model may comprise a clustering model (e.g., a centroid-based clustering model, a distribution-based clustering model, a density-based clustering model, a grid-based clustering model, a hierarchical clustering model) that compares the received data (e.g., position data, environmental data, and/or image output data) to benchmark data sets, and determines a correction to a parameter of the received data that would change the classification obtained from the first machine learning model from unergonomic to ergonomic.

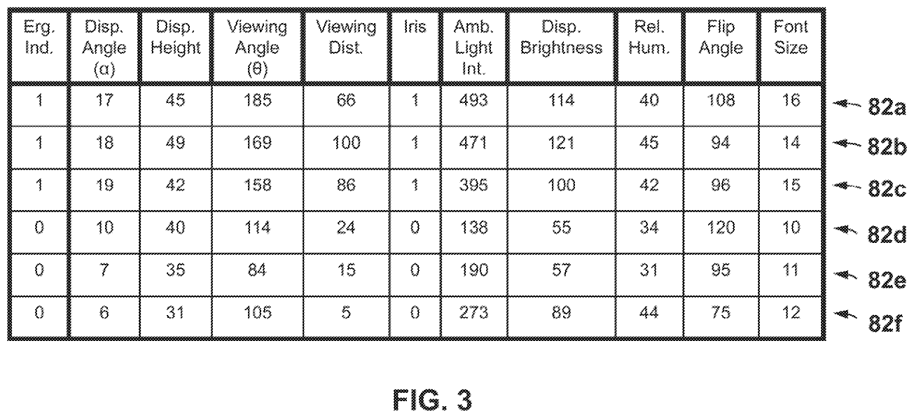

For instance, reference is now made to FIG. 3, which shows a plurality of benchmark data sets 82a-82f, each including a number of data points corresponding to the position data, image output data, environmental data, and/or parameters determined therewith. In addition, each benchmark data set 82a-82f may include an “ergonomic indicator” to indicate whether the benchmark data sets 82a-82f correspond with either an ergonomic or unergonomic interaction between a user and the electronic device 10. Because the ergonomic indicator may represent a binary classification, it may be represented in the benchmark data sets 82a-82f as either a “1” for an ergonomic interaction or a “0” for an unergonomic interaction. In some examples, the benchmark data sets 82a-82f may comprise the labeled data (or a subset thereof) used to train the first machine learning model. In some examples, the benchmark data sets 82a-82f (or some of the benchmark data sets 82a-82f) may be derived from past collected data from the user 5 (FIG. 1) that was confirmed to correspond with either an ergonomic or unergonomic interaction with the electronic device 10 (FIG. 1).

Referring now to FIGS. 1-3, during operations the second machine learning model may compare the received data (e.g., position data, image output data, environmental data, and/or parameters determined therewith) with the benchmark data sets 82a-82f and based on this determination may determine that the received data is clustered with one (or a plurality) of the benchmark data sets 82a-82f. A comparison of the received data and the selected benchmark data sets 82a-82f (e.g., via error comparison) may yield a suggested correction to a parameter or parameters of the electronic device 10 that may change the classification of the interaction from unergonomic (having an ergonomic indicator of “0”) to ergonomic (having an ergonomic indicator of “1”).

In some examples, the second machine learning model may determine a correction to: (1) the angular position of the display device 18 about the hinge 13 (e.g., as represented by the angle α); (2) an output parameter of the display device 18 (e.g., font size, brightness); and/or (3) a volume output from the speaker 60. In some examples, the second machine learning model may comprise a plurality of models as described above—each model to determine a correction for a given parameter (e.g., the angle α, an output parameter of display device 18, the volume of speaker 60) of the electronic device 10 to change the classification obtained from the first machine learning model from unergonomic to ergonomic. The adjusted parameter and the magnitude of the correction(s) may depend on the comparison of the received data with the benchmark data performed by the second machine learning model.

In an example scenario, user 5 may be sitting too close to the display device 18, which may cause the distance D, angles α, β, and other parameters to be associated with values that may result in an unergonomic classification for the ergonomic indicator via the first machine learning model. Accordingly, a comparison of the received data with the benchmarking data sets 82a-82f via the second machine learning model may provide a correction to the angular position of the display device 18 about hinge 13 (e.g., as represented by the angle α) that may better correspond the received data with one of the benchmark data sets 82a-82c that includes an ergonomic indicator of “1” (to indicate an ergonomic interaction).

In another example scenario, user 5 may be viewing images with a font size that is too small for the viewing distance D and/or may be using a brightness setting on the display device 18 that is incompatible with the ambient light intensity, such that the received data is classified as unergonomic via the first machine learning model. Accordingly, a comparison of the received data with the benchmarking data sets 82a-82f via the second machine learning model may provide corrections to the font size and/or brightness of the display device 18 that may better correspond the received data with one of the benchmark data sets 82a-82c that includes an ergonomic indicator of “1” (to indicate an ergonomic interaction).

In still another example scenario, user 5 may be using a volume setting for the speaker 60 that is inappropriately high based on the viewing distance D and angle of the head of the user 5 relative to speaker 60 (which may be determined or inferred using the angle β and/or the angle θ) such that the received data is classified as unergonomic via the first machine learning model. Accordingly, a comparison of the received data with the benchmarking data sets 82a-82f via the second machine learning model may provide corrections to the volume output from the speaker 60 that may better correspond the received data with one of the benchmark data set 82a-82c that includes an ergonomic indicator of “1” (to indicate an ergonomic interaction).

In some examples, the corrections to the parameter(s) of the received data determined via the second machine learning model may be communicated to the user, such that the user 5 may manually, via physical interaction with the electronic device 10 and/or suitable menu selections provided by the electronic device 10, implement the suggested changes. However, in some examples, the electronic device 10 may automatically implement the suggested corrections determined by the second machine learning model.

For instance, as shown in FIG. 2, in some examples, a driver 70 may be coupled to the hinge 13 and may be actuated by controller 50 to rotate the first housing member 14 about the hinge 13 relative to the second housing member 16 to thereby adjust the angle α shown in FIG. 1. Driver 70 may comprise any suitable driving device or assembly (e.g., electric motor, magnetic motor, linear actuator). Thus, during operations, controller 50 may actuate driver 70 to adjust the angular position of the display device 18 based on a correction determined by the second machine learning model. In addition, in some examples, the controller 50 may automatically adjust various output parameters of the display device 18, such as, for instance font size and/or brightness, and/or the volume output of speaker 60 based on the correction(s) determined by the second machine learning model.

Additional examples of the machine-readable instructions 100, 200, 300 that may be executed by processor 52 of controller 50 to perform the functions generally described above will now be discussed herein. The machine-readable machine-readable instructions 100, 200, 300 may comprise examples of machine-readable instructions 56 shown in FIG. 2. Thus, in describing the features of machine-readable instructions 100, 200, 300, continuing reference will be made to the features shown in FIGS. 1-3 and described above.

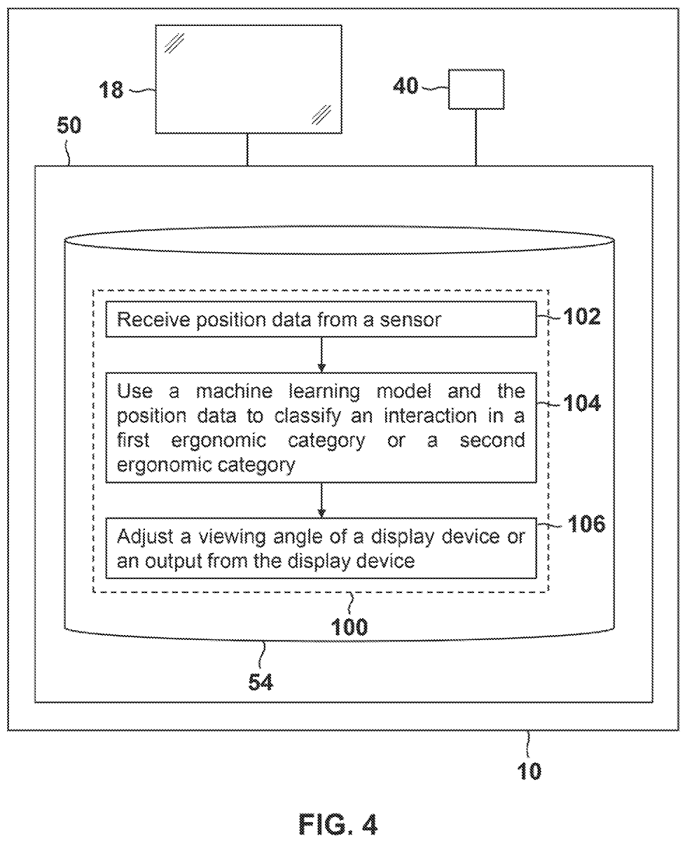

Referring now to FIG. 4, in some examples, the controller 50 may execute machine-readable instructions 100 to adjust angular position of the display device 18 (e.g., the angle α shown in FIG. 1) or an output from the display device 18 to change a classification of a user's interaction with the electronic device 10. Specifically, machine-readable instructions 100 include receiving position data from a sensor 40 at block 102. As previously described, the position data may comprise data that indicates the position and orientation of a user (e.g., or a particular body-part of the user such as the head) relative to the display device 18. In addition, as is also previously described, the position data may be received by the image sensor 40, and/or other sensors (e.g., angle detecting sensor 68).

In addition, the machine-readable instructions 100 include using a machine learning model and the position data to classify an interaction of the user with the electronic device 10 in a first ergonomic category or a second ergonomic category at block 104. The machine learning model may comprise the first machine learning model described above. The first ergonomic category may correspond with an interaction that is considered unergonomic such that the interaction may cause injury. Conversely, the second ergonomic category may correspond with an interaction that is considered ergonomic such that the interaction may avoid injury.

Further, the machine-readable instructions 100 include adjusting an angular position of the display device 18 or an output from the display device 18 response to a classification of the interaction in the first ergonomic category at block 106. For instance, in some examples, the adjustment of the angular position or the output parameter may be determined via the second machine learning model as described above. In addition, the adjustment may be implemented by the controller 50 by actuating a driver (e.g., driver 70 shown in FIG. 2) of the electronic device 10, and/or by adjusting signals that are communicated to the display device 18 (e.g., to adjust font size, brightness).

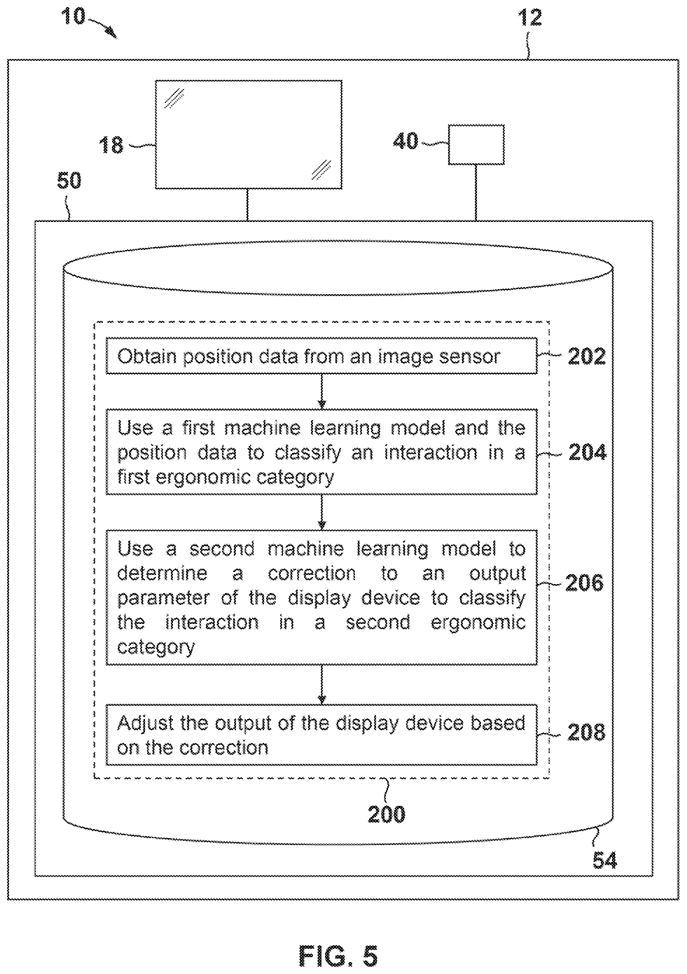

Referring now to FIG. 5, in some examples, controller 50 may execute machine-readable instructions 200 to adjust an output of the display device 18 to change a classification of a user's interaction with the electronic device 10. Specifically, machine-readable instructions include obtaining position data from an image sensor at block 202. The image sensor used to obtain the position data may comprise the image sensor 40 previously described above.

In addition, machine-readable instructions 200 include using a first machine learning model and the position data to classify an interaction of the user with the electronic device 10 in a first ergonomic category at block 204. The first ergonomic category may correspond with an interaction that is considered unergonomic, such that the interaction may cause injury. In addition, the first machine learning model in block 204 may comprise the first machine learning model described above.

Further, machine-readable instructions 200 include using a second machine learning model to determine a correction to an output of the display device 18 to classify the interaction in a second ergonomic category at block 206. In some, examples, the second ergonomic category may correspond with an interaction that is considered ergonomic such that the interaction may avoid injury. In addition, the second machine learning model of block 206 may comprise the second machine learning model described above.

Still further, machine-readable instructions 300 include adjusting the output of the display device based on the correction at block 208. The adjustment may comprise a change to an output parameter of the display device 18, such as, for example, the font size and/or the brightness of the display device 18.

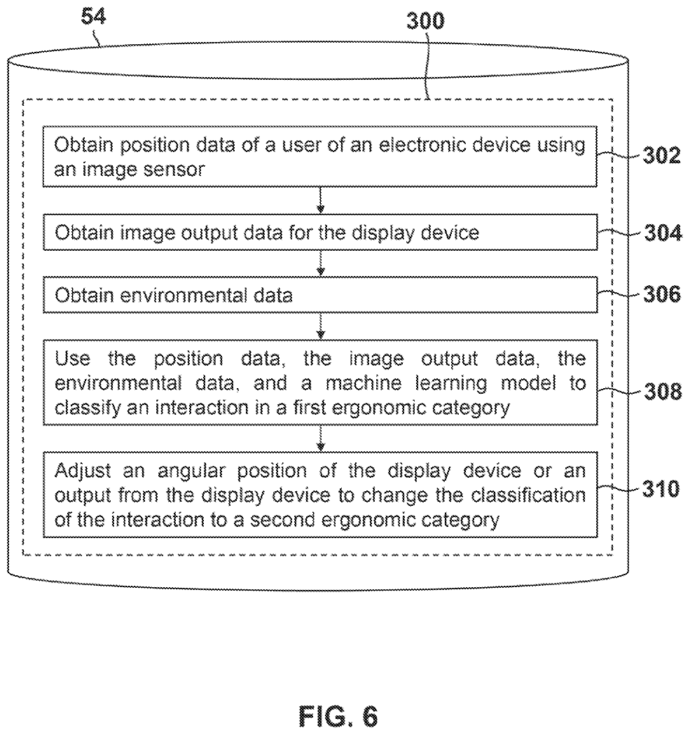

Referring now to FIG. 6, some examples may comprise machine-readable instructions for adjusting an angular position of a display device or an output from the display device to change a classification of a user's interaction with the electronic device 10. Specifically, machine-readable instructions 300 may comprise obtaining position data of a user using an image sensor at block 302. As described above, the position data may comprise data that indicates a position and orientation of the user relative to the display device 18. In some examples, the image sensor may comprise the image sensor 40 described above.

In addition, the machine-readable instructions 300 may comprise obtaining image output data for the display device at block 304. As described above, the image output data may comprise information related to images output by the display device. In some examples, the image output data may comprise output parameters such as font size, brightness, contrast, etc. of the display device 18.

Further, the machine-readable instructions 300 may comprise obtaining environmental data at block 306. As described above, the environmental data may comprise an environmental condition within the environment surrounding the electronic device. The environmental data may be obtained by a plurality of sensors, such as an ambient light sensor (e.g., ambient light sensor 62 in FIG. 2) and/or a humidity sensor (e.g., humidity sensor 66 in FIG. 2), a microphone (e.g., microphone 64 in FIG. 2).

Still further, machine-readable instructions 300 include using the position data, the image output data, the environmental data, and a machine learning model to classify an interaction of the user with the electronic device in a first ergonomic category. The first ergonomic category may correspond with an interaction that is considered unergonomic, such that the interaction may cause injury. In addition, the first machine learning model may comprise the first machine learning model described above.

Also, the machine-readable instructions 300 include adjusting an angular position of the display device or an output from the display device to change the classification of the interaction to a second ergonomic category. In some, examples, the second ergonomic category may correspond with an interaction that is considered ergonomic such that the interaction may avoid injury. In addition, as described above, the angular position of the display device may be adjusted by actuating a driver coupled to the hinge 13 (e.g., driver 70 shown in FIG. 2). Also, as described above, the output from the display may be adjusted by adjusting one of a font size, brightness, etc. for the images output by the display device.

Accordingly, examples disclosed herein include electronic devices that may receive data from a sensor (or a plurality of sensors), and based on the received data, may classify a user's interaction with the electronic device as either ergonomic or unergonomic. Thus, through use of the examples disclosed herein, a user may more consistently achieve and maintain ergonomic interaction with the electronic device so as to avoid injury.

In the figures, certain features and components disclosed herein may be shown exaggerated in scale or in somewhat schematic form, and some details of certain elements may be omitted in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

As used herein, including in the claims, the word “or” is used in an inclusive manner. For example, “A or B” means any of the following: “A” alone, “B” alone, or both “A” and “B.”

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device comprising:
a display device;
a sensor to detect position data of a user of the electronic device, wherein the position data indicates a position and orientation of the user relative to the display device; and
a controller coupled to the sensor and the display device, wherein the controller is to:
receive the position data from the sensor;
use a machine learning model and the position data to classify an interaction of the user with the electronic device in a first ergonomic category or a second ergonomic category; and
adjust an angular position of the display device or an output from the display device responsive to a classification of the interaction in the first ergonomic category.

2. The electronic device of claim 1, wherein the controller is to:
receive image output data comprising font size and brightness of the output from the display device; and
use the image output data to classify the interaction.

3. The electronic device of claim 1, wherein the controller is to adjust the angular position of the display device or the output from the display device by:
comparing the position data to benchmark data that is associated with the second ergonomic category;
determining a correction to the angular position of the display device or the output from the display device to conform the position data with the benchmark data; and
adjusting the angular position of the display device or the output from the display device based on the correction.

4. The electronic device of claim 1, wherein the machine learning model comprises a logistic regression model.

5. The electronic device of claim 1, further comprising a speaker, wherein the controller is to adjust a volume of the speaker responsive to the classification of the interaction into the first ergonomic category.

6. An electronic device comprising:
a housing;
a display device coupled to the housing;
an image sensor coupled to the housing to detect position data of a user of the electronic device, wherein the position data indicates a position and orientation of the user relative to the display device; and
a controller coupled to the image sensor; wherein the controller is to:
obtain the position data from the image sensor;
use a first machine learning model and the position data to classify an interaction of the user with the electronic device in a first ergonomic category;
responsive to the classification, use a second machine learning model to determine a correction to an output parameter of the display device to classify the interaction of the user in a second ergonomic category; and
adjust an output of the display device based on the correction.

7. The electronic device of claim 6, wherein the controller is to:
obtain environmental data from a sensor, wherein the environmental data comprises an environmental condition of the environment surrounding the electronic device; and
use the environmental data to classify the interaction.

8. The electronic device of claim 7, the output parameter comprises a font size or a brightness.

9. The electronic device of claim 8, wherein the environmental condition comprises ambient light intensity or relative humidity.

10. The electronic device of claim 6, wherein the second machine learning model is to compare the position data with benchmark data that corresponds an interaction in the second ergonomic category to determine the correction.

11. A non-transitory, machine-readable medium including instructions, which, when executed by a processor of an electronic device, cause the processor to:
obtain position data of a user of the electronic device using an image sensor coupled to the electronic device, wherein the position data indicates a position and orientation of the user relative to a display device of the electronic device;
obtain image output data for the display device, wherein the image output data comprises information related to images output by the display device;
obtain environmental data that comprises an environmental condition within the environment surrounding the electronic device;
use the position data, the image output data, the environmental data, and a machine learning model to classify an interaction of the user with the electronic device in a first ergonomic category; and
adjust an angular position of the display device or an output from the display device to change the classification of the interaction to a second ergonomic category.

12. The non-transitory machine-readable medium of claim 11, wherein the machine learning model comprises a logistic regression model.

13. The non-transitory machine-readable medium of claim 11, wherein the instructions, which when executed by the processor, cause the processor to:
compare the position data, the image output data, and the environmental data to benchmark data that is associated with an interaction that is classified in the second ergonomic category;
determine a correction of an angular position of the display device or an output from the display device to conform the position data, the image output data, and the environmental data to the benchmark data; and
apply the correction to the display device.

14. The non-transitory machine-readable medium of claim 13, wherein the electronic device comprises a housing including a first housing member pivotably coupled to a second housing member with a hinge, wherein the display device is coupled to the first housing member, and wherein the angular position of the display device comprises an angular position of the first housing member about the hinge relative to the second housing member.

15. The non-transitory machine-readable medium of claim 13, wherein the output from the display device comprises a font size or a brightness.
